(19) United States
(12) Patent Application Publication
(10) Pub. No.: US 2018/0025070 A1
(43) Pub. Date: Jan. 25, 2018

(54) CLUSTERING APPLICATIONS FOR QUERY PROCESSING

(71) Applicant: Microsoft Technology Licensing, LLC, Redmond, WA (US)

(72) Inventors: Aman Singhal, Bellevue, WA (US); Marcelo De Barros, Redmond, WA (US); Sidd Shenoy, Sammamish, WA (US)

(73) Assignee: Microsoft Technology Licensing, LLC, Redmond, WA (US)

(21) Appl. No.: 15/248,291

(22) Filed: Aug. 26, 2016

Related U.S. Application Data
(60) Provisional application No. 62/365,930, filed on Jul. 22, 2016.

(51) Int. Cl. G06F 17/30

(52) U.S. Cl. CPC G06F 17/30598; G06F 17/30424; G06F 17/30864

(57) ABSTRACT

Non-limiting examples of the present disclosure describe clustering of application data for identification of equivalent applications across different platforms. Exemplary clusters of application data may be utilized to improve results provided for query processing, among other examples. In one example, a query is received from a computing device. Web results may be accessed for the received query. An exemplary cluster may be identified that comprises application data for equivalent applications of different platforms. The cluster may be identified based on analysis of the web results. A specific application from the cluster may be determined based on the computing device associated with the received query. Data for the specific application may be output. In one example, data for the specific application is transmitted to the computing device. Other examples are also described.

### CROSS-REFERENCE TO RELATED APPLICATIONS

This application claims the benefit of U.S. provisional application Ser. No. 62/365,930, filed Jul. 22, 2016, which is herein incorporated by reference in its entirety.

### BACKGROUND

Often times, a user may enter a query and receive search results that are not designed for the device of the user. As such, examples of the present application are directed to the general technical environment related to improving query processing and efficiency of devices associated with query processing, among other examples.

### SUMMARY

Non-limiting examples describe management of exemplary clusters of application data that may be used for identification of equivalent applications across different platforms. An exemplary cluster may be used to improve query processing, among other examples.

In one example, applications may be enumerated from an application store of a specific platform. Application data of other platforms may be parsed based data associated with a specific application. As an example, an application name of an enumerated application may be used to parse application data of other platforms. In one example, parsing of the application may comprise obtaining search results from a search engine and parsing the search results to identify the application data. One or more equivalent applications may be determined for the enumerated application. In examples, a determination of equivalent applications comprises: identifying candidate equivalent applications based on application name and comparing attribute data of the enumerated application with attribute data of the candidate equivalent applications. A comparison of attribute data may further comprise determining a similarity score for equivalency based on similarity from any of: application name, publisher name, application category, and description metadata, among other examples. A cluster for application equivalence may be generated based on the determination of equivalence. An exemplary cluster may comprise data for the enumerated application and data for the equivalent applications identified.

Other non-limiting examples of the present disclosure describe use of an exemplary cluster that comprises application data for equivalent applications across different platforms. Exemplary clusters of application data may be utilized to improve results provided for query processing, among other examples. In one example, a query is received from a computing device. Web results may be accessed for the received query. For instance, web results may be received from a search engine service that interfaces with a service for clustering application data. In other examples, processing operations described herein may be integrated into a search engine service, among other application examples. In such an instance, a search engine service may process the query using processing operations described herein. An exemplary cluster may be identified that comprises application data for equivalent applications of different platforms. The cluster may be identified based on analysis of the web results. For instance, one or more uniform resource locators may be extracted from the web results and the cluster is identified using the one or more extracted uniform resource locators. A specific application from the cluster may be determined based on the computing device associated with the received query. Data for the specific application may be output. In one example, output of the data for the specific application comprises transmitting data for the specific application to the computing device. In another example, output of the data for the specific application comprises displaying the data for the specific application on a display that may be connected with a computing device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 is a block diagram illustrating an example of a computing device with which aspects of the present disclosure may be practiced.

FIGS. 2A and 2B are simplified block diagrams of a mobile computing device with which aspects of the present disclosure may be practiced.

FIG. 3 is a simplified block diagram of a distributed computing system in which aspects of the present disclosure may be practiced.

FIG. 4 is an exemplary method related to management of exemplary clusters with which aspects of the present disclosure may be practiced.

FIG. 5 is an exemplary method related to query processing with which aspects of the present disclosure may be practiced.

FIG. 6 illustrates an exemplary system implementable on one or more computing devices on which aspects of the present disclosure may be practiced.

### DETAILED DESCRIPTION

Examples herein describe management of exemplary clusters of application data that may be used for identification of equivalent applications across different platforms. Exemplary clusters of application data may be utilized to improve results provided for query processing, among other examples. For instance, web results may be returned that are specifically tailored for a device that issued the query. As an illustrative example, a user may search for an application (to download) and receive results for a desktop version of the application rather than a mobile version of the application when the user is using a mobile phone to conduct a search. In a further example, if a user enters a query for a TRIPADVISOR application on GOOGLE.COM, where the query was issued from a WINDOWS Desktop/Tablet, a user may only see a web result for an application that is on the WINDOWS Store. However, when clicking on this web result, the user may quickly identify that this particular application is only meant for a WINDOWS PHONE, leading the user to become very dissatisfied with the irrelevant result and a search engine service itself.

In examples, processing operations are applied that group equivalent applications into clusters. As an example, multiple versions of the same application may be created for different platforms (e.g. APPLE version and a WINDOWS version, etc.) or for different types of devices within a same platform (e.g. IPHONE and MACBOOK). A platform is type of digital distribution service for applications. Examples of platforms may include application stores for different companies such as GOOGLE, MICROSOFT, APPLE, BAIDU, etc. A platform may comprise a number of device-specific applications such as applications tailored for mobile phones, tablets, desktop computers, gaming consoles, etc. An exemplary cluster may comprise application data for one or more applications that are determined to be equivalent applications. Equivalent applications may be interpreted as versions of the same application that may exist across platforms. As an example, multiple versions of the same application may be created for different platforms (e.g. APPLE IPHONE version and a WINDOWS PHONE version, etc.). Equivalent applications may further comprise versions of the same application that may exist within the same platform. For instance, a particular platform may have a desktop version of an application and a mobile version of the same application. Consider an example where an application may be a TRIPADVISOR application that provides travel related reviews. An exemplary cluster may comprise application data for TRIPADVISOR applications tailored for an APPLE IPHONE, ANDROID based phones, MICROSOFT WINDOWS PHONES, MICROSOFT SURFACE tablets, APPLE IPAD tablets, etc. In examples, a query may be received from a MICROSOFT WINDOWS PHONE requesting travel related application. Processing operations described herein can enable a system or service to readily identify a suitable web result for the received query including providing application data and/or a link (e.g. uniform resource locator (URL)) to a specific travel related application that is optimal for operation on the MICROSOFT WINDOWS PHONE.

Accordingly, the present disclosure provides a plurality of technical advantages including but not limited to: improved organization for data of similar applications through exemplary clusters, offline maintenance for optimizing exemplary clusters, improved query processing including more efficient operation of processing devices (e.g., saving computing cycles/computing resources) during query processing, extensibility to integrate processing operations described herein within different applications such as search engine services, optimizing web results for searches, and improved user interaction, among other examples.

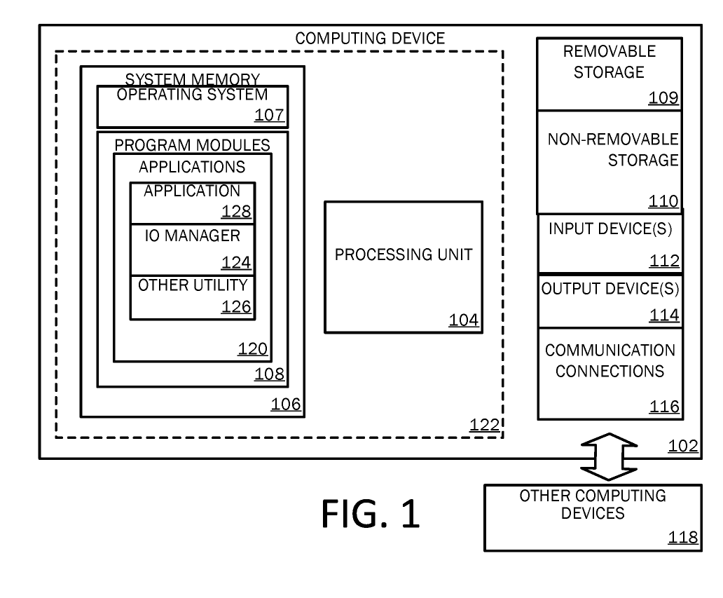

FIGS. 1-3 and the associated descriptions provide a discussion of a variety of operating environments in which examples of the invention may be practiced. However, the devices and systems illustrated and discussed with respect to FIGS. 1-3 are for purposes of example and illustration and are not limiting of a vast number of computing device configurations that may be utilized for practicing examples of the invention, described herein.

FIG. 1 is a block diagram illustrating physical components of a computing device 102, for example a mobile processing device, with which examples of the present disclosure may be practiced. For example, computing device 102 may be an exemplary computing device configured for management of exemplary clusters for application equivalence and query processing as described in examples herein. In a basic configuration, the computing device 102 may include at least one processing unit 104 and a system memory 106. Depending on the configuration and type of computing device, the system memory 106 may comprise, but is not limited to, volatile storage (e.g., random access memory), non-volatile storage (e.g., read-only memory), flash memory, or any combination of such memories. The system memory 106 may include an operating system 107 and one or more program modules 108 suitable for running software programs/modules 120 such as IO manager 124, other utility 126 and application 128. As examples, system memory 106 may store instructions for execution. Other examples of system memory 106 may store data associated with applications. The operating system 107, for example, may be suitable for controlling the operation of the computing device 102. Furthermore, examples of the invention may be practiced in conjunction with a graphics library, other operating systems, or any other application program and is not limited to any particular application or system. This basic configuration is illustrated in FIG. 1 by those components within a dashed line 122. The computing device 102 may have additional features or functionality. For example, the computing device 102 may also include additional data storage devices (removable and/or non-removable) such as, for example, magnetic disks, optical disks, or tape. Such additional storage is illustrated in FIG. 1 by a removable storage device 109 and a non-removable storage device 110.

As stated above, a number of program modules and data files may be stored in the system memory 106. While executing on the processing unit 104, program modules 108 (e.g., Input/Output (I/O) manager 124, other utility 126 and application 128) may perform processes including, but not limited to, one or more of the stages of the operations described throughout this disclosure. Other program modules that may be used in accordance with examples of the present invention may include electronic mail and contacts applications, word processing applications, spreadsheet applications, database applications, slide presentation applications, drawing or computer-aided application programs, photo editing applications, authoring applications, etc.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 1 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the computing device 102 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

The computing device 102 may also have one or more input device(s) 112 such as a keyboard, a mouse, a pen, a sound input device, a device for voice input/recognition, a touch input device, etc. The output device(s) 114 such as a display, speakers, a printer, etc. may also be included. The aforementioned devices are examples and others may be used. The computing device 102 may include one or more communication connections 116 allowing communications with other computing devices 118. Examples of suitable communication connections 116 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 106, the removable storage device 109, and the non-removable storage device 110 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 102. Any such computer storage media may be part of the computing device 102. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

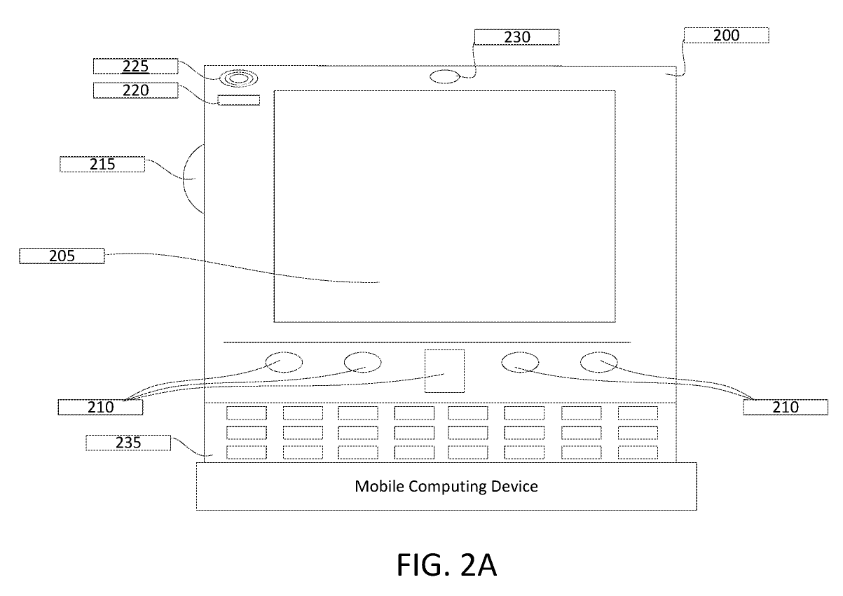

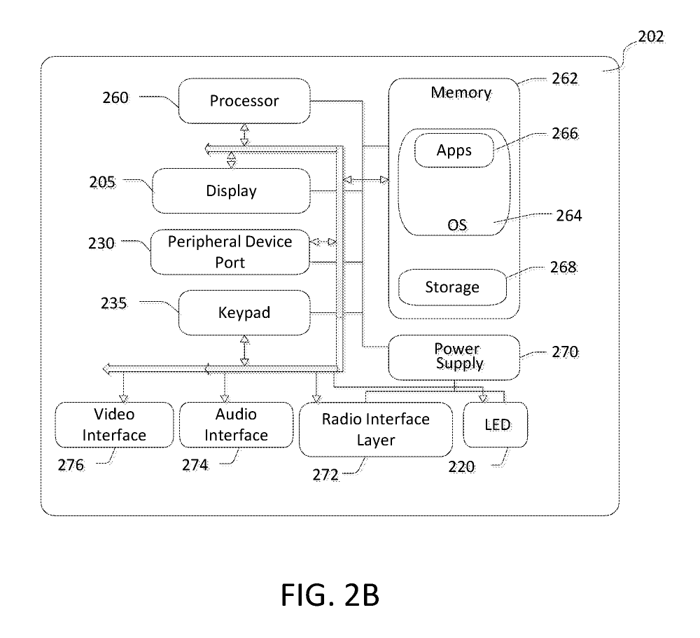

FIGS. 2A and 2B illustrate a mobile computing device 200, for example, a mobile telephone, a smart phone, a personal data assistant, a tablet personal computer, a phablet, a slate, a laptop computer, and the like, with which examples of the invention may be practiced. Mobile computing device 200 may be an exemplary computing device configured for management of exemplary clusters for application equivalence and query processing as described in examples herein. With reference to FIG. 2A, one example of a mobile computing device 200 for implementing the examples is illustrated. In a basic configuration, the mobile computing device 200 is a handheld computer having both input elements and output elements. The mobile computing device 200 typically includes a display 205 and one or more input buttons 210 that allow the user to enter information into the mobile computing device 200. The display 205 of the mobile computing device 200 may also function as an input device (e.g., a touch screen display). If included, an optional side input element 215 allows further user input. The side input element 215 may be a rotary switch, a button, or any other type of manual input element. In alternative examples, mobile computing device 200 may incorporate more or less input elements. For example, the display 205 may not be a touch screen in some examples. In yet another alternative example, the mobile computing device 200 is a portable phone system, such as a cellular phone. The mobile computing device 200 may also include an optional keypad 235. Optional keypad 235 may be a physical keypad or a “soft” keypad generated on the touch screen display or any other soft input panel (SIP). In various examples, the output elements include the display 205 for showing a GUI, a visual indicator 220 (e.g., a light emitting diode), and/or an audio transducer 225 (e.g., a speaker). In some examples, the mobile computing device 200 incorporates a vibration transducer for providing the user with tactile feedback. In yet another example, the mobile computing device 200 incorporates input and/or output ports, such as an audio input (e.g., a microphone jack), an audio output (e.g., a headphone jack), and a video output (e.g., a HDMI port) for sending signals to or receiving signals from an external device.

FIG. 2B is a block diagram illustrating the architecture of one example of a mobile computing device. That is, the mobile computing device 200 can incorporate a system (i.e., an architecture) 202 to implement some examples. In one examples, the system 202 is implemented as a “smart phone” capable of running one or more applications (e.g., browser, e-mail, calendaring, contact managers, messaging clients, games, and media clients/players). In some examples, the system 202 is integrated as a computing device, such as an integrated personal digital assistant (PDA), tablet and wireless phone.

One or more application programs 266 may be loaded into the memory 262 and run on or in association with the operating system 264. Examples of the application programs include phone dialer programs, e-mail programs, personal information management (PIM) programs, word processing programs, spreadsheet programs, Internet browser programs, messaging programs, and so forth. The system 202 also includes a non-volatile storage area 268 within the memory 262. The non-volatile storage area 268 may be used to store persistent information that should not be lost if the system 202 is powered down. The application programs 266 may use and store information in the non-volatile storage area 268, such as e-mail or other messages used by an e-mail application, and the like. A synchronization application (not shown) also resides on the system 202 and is programmed to interact with a corresponding synchronization application resident on a host computer to keep the information stored in the non-volatile storage area 268 synchronized with corresponding information stored at the host computer. As should be appreciated, other applications may be loaded into the memory 262 and run on the mobile computing device 200 described herein.

The system 202 has a power supply 270, which may be implemented as one or more batteries. The power supply 270 might further include an external power source, such as an AC adapter or a powered docking cradle that supplements or recharges the batteries.

The system 202 may include peripheral device port 230 that performs the function of facilitating connectivity between system 202 and one or more peripheral devices. Transmissions to and from the peripheral device port 230 are conducted under control of the operating system (OS) 264. In other words, communications received by the peripheral device port 230 may be disseminated to the application programs 266 via the operating system 264, and vice versa.

The system 202 may also include a radio interface layer 272 that performs the function of transmitting and receiving radio frequency communications. The radio interface layer 272 facilitates wireless connectivity between the system 202 and the “outside world,” via a communications carrier or service provider. Transmissions to and from the radio interface layer 272 are conducted under control of the operating system 264. In other words, communications received by the radio interface layer 272 may be disseminated to the application programs 266 via the operating system 264, and vice versa.

The visual indicator 220 may be used to provide visual notifications, and/or an audio interface 274 may be used for producing audible notifications via the audio transducer 225 (e.g. identified in FIG. 2A). In the illustrated example, the visual indicator 220 is a light emitting diode (LED) and the audio transducer 225 is a speaker. These devices may be directly coupled to the power supply 270 so that when activated, they remain on for a duration dictated by the notification mechanism even though the processor 260 and other components might shut down for conserving battery power. The LED may be programmed to remain on indefinitely until the user takes action to indicate the powered-on status of the device. The audio interface 274 is used to provide audible signals to and receive audible signals from the user. For example, in addition to being coupled to the audio transducer 225, the audio interface 274 may also be coupled to a microphone to receive audible input, such as to facilitate a telephone conversation. In accordance with examples of the present invention, the microphone may also serve as an audio sensor to facilitate control of notifications, as will be described below. The system 202 may further include a video interface 276 that enables an operation of an on-board camera 230 to record still images, video stream, and the like.

A mobile computing device 200 implementing the system 202 may have additional features or functionality. For example, the mobile computing device 200 may also include additional data storage devices (removable and/or non-removable) such as, magnetic disks, optical disks, or tape. Such additional storage is illustrated in FIG. 2B by the non-volatile storage area 268.

Data/information generated or captured by the mobile computing device 200 and stored via the system 202 may be stored locally on the mobile computing device 200, as described above, or the data may be stored on any number of storage media that may be accessed by the device via the radio 272 or via a wired connection between the mobile computing device 200 and a separate computing device associated with the mobile computing device 200, for example, a server computer in a distributed computing network, such as the Internet. As should be appreciated such data/information may be accessed via the mobile computing device 200 via the radio 272 or via a distributed computing network. Similarly, such data/information may be readily transferred between computing devices for storage and use according to well-known data/information transfer and storage means, including electronic mail and collaborative data/information sharing systems.

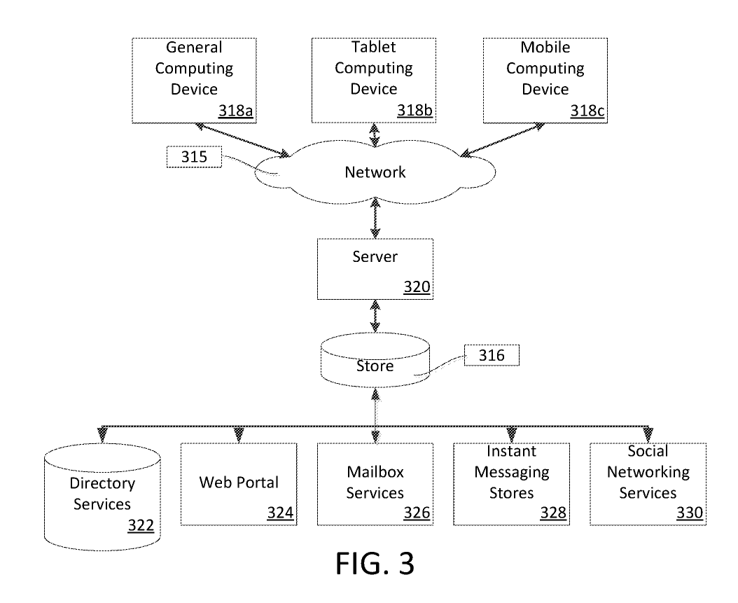

FIG. 3 illustrates one example of the architecture of a system for provisioning an application that reliably accesses target data on a storage system and handles communication failures to one or more client devices, as described above. The system of FIG. 3 may be an exemplary system configured for implementing operations for management of exemplary clusters for application equivalence and query processing as described in examples herein. Target data accessed, interacted with, or edited in association with programming modules 108, applications 120, and storage/memory may be stored in different communication channels or other storage types. For example, various documents may be stored using a directory service 322, a web portal 324, a mailbox service 326, an instant messaging store 328, or a social networking site 330, application 128, IO manager 124, other utility 126, and storage systems may use any of these types of systems or the like for enabling data utilization, as described herein. A server 320 may provide storage system for use by a client operating on general computing device 102 and mobile device(s) 200 through network 315. By way of example, network 315 may comprise the Internet or any other type of local or wide area network, and client nodes may be implemented as a computing device 102 embodied in a personal computer, a tablet computing device, and/or by a mobile computing device 200 (e.g., mobile processing device). Any of these examples of the client computing device 102 or 200 may obtain content from the store 316.

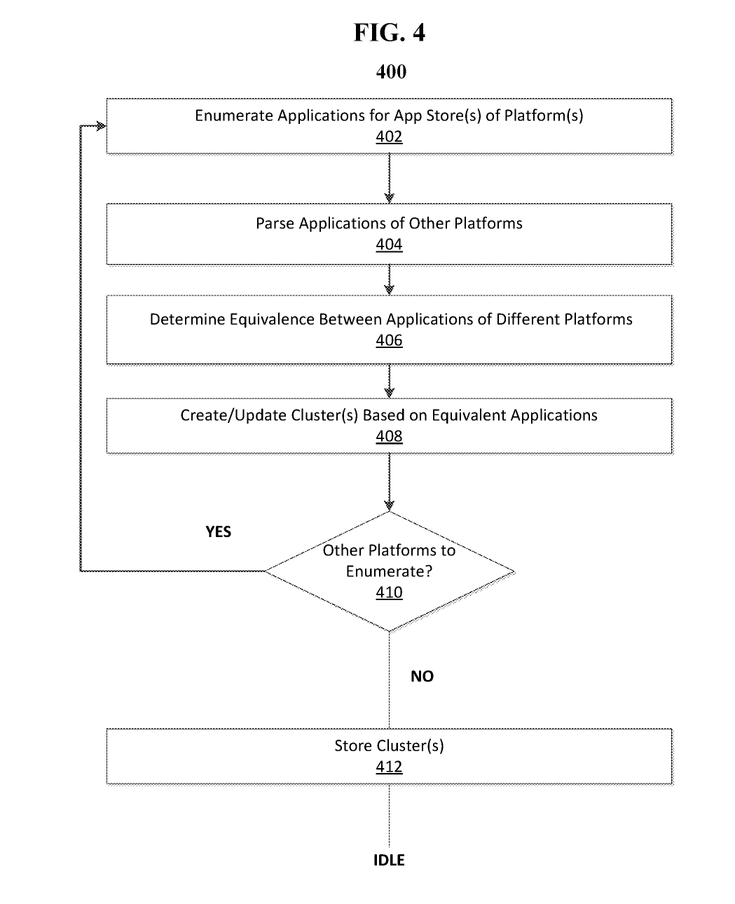

FIG. 4 is an exemplary method 400 related to management of exemplary clusters with which aspects of the present disclosure may be practiced. As an example, method 400 may be executed by an exemplary processing device and/or system such as those shown in FIGS. 1-3. In examples, method 400 may execute on a device comprising at least one processor configured to store and execute operations, programs or instructions. Operations performed in method 400 may correspond to operations executed by a system and/or service that execute computer programs, application programming interfaces (APIs), neural networks or machine-learning processing, among other examples. As an example, processing operations executed in method 400 may be performed by one or more hardware components. In another example, processing operations executed in method 400 may be performed by one or more software components. In some examples, processing operations described in method 400 may be executed by one or more applications/services associated with a web service that has access to a plurality of application/services, devices, knowledge resources, etc. Method 400 may relate to but is not limited to offline examples where exemplary clusters are generated, updated and maintained for application to real-time query processing.

Method 400 begins at operation 402, where applications are enumerated for an application store of an exemplary platform. As described above, a platform is type of digital distribution service for applications. Examples of platforms may include application stores for different companies such as GOOGLE, MICROSOFT, APPLE, BAIDU, etc. A platform may comprise a number of device-specific applications such as applications tailored for mobile phones, tablets, desktop computers, gaming consoles, etc. An applications store may be an application or service that provides a listing of available applications (e.g. for download and/or purchase). In examples where a first exemplary cluster of equivalent applications is being generated, operation 402 may comprise parsing a single application store for a specific platform. In alternative examples, operation 402 may comprise parsing multiple platforms in parallel to enumerate applications within specific application stores.

In examples, processing operation executed in operation 402 may evaluate and categorize applications within a specific application store (e.g. APPLE application store). In one example, computer software such as an application programming interface (API) may be utilized to evaluate a feed of an application store provided by a specific platform. Examples described herein may relate to identifying any number of types of information for a specific application. In one example of operation 402, applications within an application store are enumerated based on application name. Operation 402 may comprise extracting a listing of application names for enumerated applications within an application store. However, one skilled in the art that understands the present disclosure should recognize that applications can be enumerated (operation 402) according to any data that is associated with a particular application.

Flow may proceed to operation 404, where applications of other platforms may be parsed. Operation 404 acquires application data for specific applications of different platforms. Application data refers to any information associated with an application that can be utilized to identify an application. For instance, application data may comprise data from an application store that describes a particular application. Application data may further comprise attribute data that relates to particular fields of application data. As described below, exemplary attribute data (e.g. particular fields of application data) may be utilized to determine equivalence among applications of different platforms. In examples, application data related to other platforms may be parsed using individual application names (or alternative data) that is used for enumeration in operation 402.

In one example, operation 404 may utilize web indexes to identify application data for exemplary platforms. For instance, operation 404 may comprise obtaining search results from a search engine and parsing the search results to identify the application data of specific platforms. For each application that is being enumerated, a query that comprises one or more application names may be transmitted to a search engine. In response to the query, web results may be acquired that may provide information on applications that may be associated with an exemplary application name. The web results are then parsed to extract applications belonging to a specific platform. For instance, a web result may contain a URL such as http://www.microsoft.com/store/apps, where an application name may be included in the URL. In one example, a particular application may be extracted from the URL. This information may be used to acquire application data for a particular application.

Application data may then be acquired for a particular application. For instance, processing operations may be executed that navigate to a webpage of a particular application (listed within an application store) and extract attribute data for the application. Exemplary attribute data may comprise but is not limited to: an application name, an application developer, an application category (e.g. categorization as to how the application is listed on an application store) and description metadata for the application, among other examples. Description metadata may relate to any descriptive details about the application including a description, summary, write-up, best-uses, reviews, timestamp information, etc.

In an alternative example, operation 404 may acquire application data by utilizing software programs to analyze feeds from application stores of different platforms and further enumerating application data for specific applications within an applications store. In any case, application data for different applications may be enumerated for evaluation.

At operation 406, equivalent applications for the enumerated application may be determined. Operation 406 may be utilized to identify one or more equivalent applications (e.g. across different platforms) for the enumerated application. As described above, equivalent applications may be interpreted as versions of the same application that may exist across platforms. As an example, multiple versions of the same application may be created for different platforms (e.g. APPLE IPHONE version and a WINDOWS PHONE version, etc.). Equivalent applications may further comprise versions of the same application that may exist within the same platform. Operation 406 may comprise: identifying candidate equivalent applications based on application name, and comparing attribute data of the enumerated application with attribute data of the candidate equivalent applications. Examples of attribute data are described above in the description for operation 404. In comparing the attribute data of the enumerated application with the attribute data of the candidate equivalent applications, operation 406 may comprise determining a similarity score for equivalency based on similarity of one or more selected from a group consisting of: application name, publisher name, application category, and description metadata.

In one example, string similarity processing operations may be applied that are utilized to evaluate similarity in application name of enumerated applications across different platforms. In one instance, a Jaccard indexing is utilized to compare similarity in application names and/or any other attributes. However, one skilled in the art should recognize that the present disclosure is not limited to such an example. Similar processing operations may be applied to evaluate a publisher name of an application. In most cases, the publisher name for applications (across different platforms) should be the same for equivalent applications. Similar to the other attribute data, similarity string processing may be used to evaluate application category and/or description metadata to determine equivalence between applications.

Operation 406 may comprise executing processing operations that utilize one or more fields of the attribute data as input to generate an output of a similarity score between applications. In one example, equivalence is achieved when there is a high degree of similarity in a case where: the application name and the publisher names match (or are pretty close; e.g. within a certain threshold analysis), and the application category and/or description metadata match (or are highly correlated). However, one skilled in the art that understands the present disclosure should recognize that different weights can be assigned to different fields of attribute data. Additionally, other attribute data for a specific application may be factored into determining a similarity between applications. Such data may include but is not limited to: timestamp data, platform specific information, user review data, etc. In some instances, a similarity score that meets certain threshold requirement may result in a match of equivalence between applications. Threshold requirements for determining similarity between applications may vary according to developers.

Flow may proceed to operation 408, where an exemplary cluster of equivalent applications may be created. Operation 408 may comprise processing operations that cluster data for applications determined to be equivalent based on processing executed in operation 406. An exemplary cluster may comprise data for the enumerated application and data for the one or more equivalent applications. Operation 408 may comprise creating clusters or groupings for each of the enumerated applications. In some examples, a cluster may comprise only data for a single application, for example, when no equivalent applications are identified.

Exemplary clusters can be updated at a later point in time. For instance, an application developer may be working on developing an equivalent application (on a different platform) for an application that was originally developed for a specific device and/or platform.

Flow may proceed to decision operation 410, where it is determined whether there are other platforms that have application data to enumerate. If so, flow branches YES and returns to operation 402. If not, flow branches NO and proceeds to operation 412 where an exemplary cluster may be stored. Clustered data for application equivalence may be stored in any type of physical or virtual memory, examples of which are described in the description of FIGS. 1-3 and 6.

In an alternative example, processing operations described in method 400 may be modified to generate exemplary clusters of applications that may be similar in type but are not equivalent. For instance, processing operations as described in operation 406 may be applied to determine applications that may be similar in type, where an exemplary cluster may be created which groups applications that are similar in type but may not be equivalent. For instance, a cluster of applications may be created that groups different travel review applications. In such an example, application data including attribute data may be processed to determine similar applications. Clustering of this nature may be useful to assist with improving efficiency during query processing, among other examples, to provide results for similar applications including during multi-turn query processing with a user.

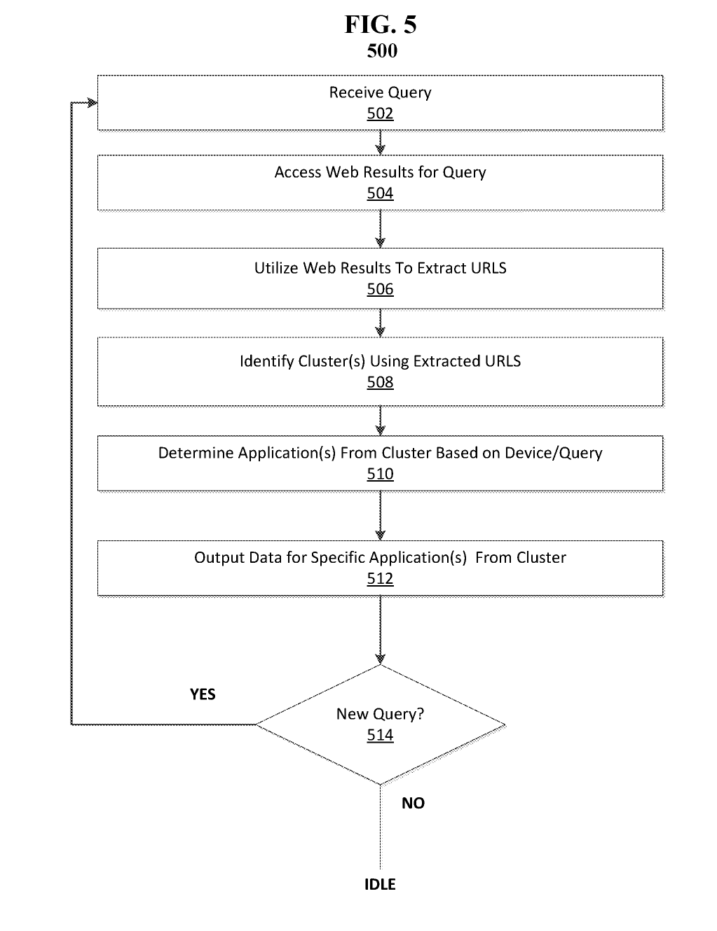

FIG. 5 is an exemplary method 500 related to query processing with which aspects of the present disclosure may be practiced. As an example, method 500 may be executed by an exemplary processing device and/or system such as those shown in FIGS. 1-3. In examples, method 500 may execute on a device comprising at least one processor configured to store and execute operations, programs or instructions. Operations performed in method 500 may correspond to operations executed by a system and/or service that execute computer programs, application programming interfaces (APIs), neural networks or machine-learning processing, among other examples. As an example, processing operations executed in method 500 may be performed by one or more hardware components. In another example, processing operations executed in method 500 may be performed by one or more software components. In some examples, processing operations described in method 500 may be executed by one or more applications/services associated with a web service that has access to a plurality of application/services, devices, knowledge resources, etc. Method 500 may relate to but is not limited to online examples, for example, where an application/service is processing a query in real-time.

Method 500 begins at operation 502, where a query may be received. In one example, a query may be received from a computing device such as a user computing device. Examples of a computing device are provided in the description of FIGS. 1-3 and 6. In one instance, a user may enter a query through an application/service executing on a computing device. Signal data associated with the query may be received with the query or from an application/service that processes the query. Signal data may include but is not limited to: device type, operating system version, timestamp data, location data, user profile data, search history data, etc. Such information (e.g. signal data) is collected in compliance with existing privacy laws.

Flow may proceed to operation 504, where web results for the received query are accessed. In one example, processing operations described herein are executed independently of (but in association with) another application such as a search engine service. In such an example, a search engine search may retrieve web results and propagate the web results for further processing as described in method 500.

In an alternative example, processing operations described herein are incorporated within an application such as a search engine service. In such a case, web results may be generated (and accessed) based on query processing executed by the search engine service.

Flow may proceed to operation 506, where the web results may be parsed. As an example, operation 506 may extract uniform resource locators (URLs) from the web results. The URLs from the web results may be utilized to identify exemplary clusters (generation of which is described in method 400) of equivalent applications.

At operation 508, an exemplary cluster is identified based on analysis of the web results. For example, an exemplary cluster may be identified through processing operations that match the extracted URLs from the web results to link data for applications within an exemplary cluster. However, one skilled in the art should recognize that any data from a web results (e.g. search index) may be utilized for comparison with fields of an exemplary cluster.

Once a cluster is identified, flow may proceed to operation 510, where a specific application from the cluster is determined based on the computing device associated with the received query. Operation 510 may recognize a particular computing device that issued the query and identify application data for an application in a cluster. Processing operations may be applied to determine an application from the cluster of equivalent applications that is best suited for the computing device that received the query. In another example, operation 510 may also factor in context of a query. For instance, a user may be searching for a mobile phone application while using a desktop computer. In such a case, operation 510 may execute processing operations identifying a mobile version of an application and a desktop version of an application as being of interest to the user.

Flow may proceed to operation 512, where data for one or more specific applications from a cluster may be output. In one case, output of the data for the specific application may comprise transmitting the data for the specific application to the computing device. In another example, output of the data for the specific application may comprise displaying the data for the specific application on a display that is associated with (or included within) a computing device.

At decision operation 514, it is determined whether a new query is received. If so, flow branches YES and returns to operation 502, where the query is received. If not, flow branches NO, where method 500 remains idle until another query is received.

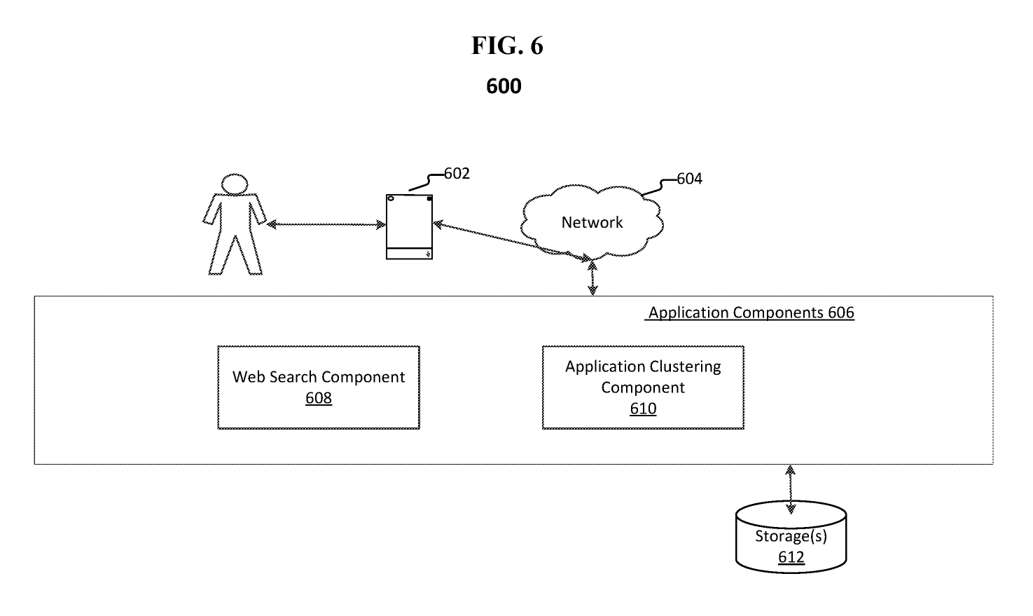

FIG. 6 illustrates an exemplary system 600 implementable on one or more computing devices on which aspects of the present disclosure may be practiced. System 600 may be an exemplary system for management of exemplary clusters for application equivalence and query processing as described in examples herein. Exemplary system 600 presented is a combination of interdependent components that interact to form an integrated whole for implementing processing operations described above. Components of system 600 may be hardware components or software implemented on and/or executed by hardware components. In examples, system 600 may include any of hardware components (e.g., ASIC, other devices used to execute/run an OS, and software components (e.g., applications, application programming interfaces, modules, virtual machines, runtime libraries) running on hardware. In one example, an exemplary system 600 may provide an environment for software components to run, obey constraints set for operating, and makes use of resources or facilities of the systems/processing devices, where components may be software (e.g., application, program, module) running on one or more processing devices. For instance, software (e.g., applications, operational instructions, modules) may be executed on a processing device such as a computer, mobile device (e.g., smartphone/phone, tablet) and/or any other type of electronic devices. As an example of a processing device operating environment, refer to operating environments of FIGS. 1-3. In other examples, the components of systems disclosed herein may be spread across multiple devices. For instance, input may be scanned on a client computing device where processing operations may occur through one or more devices in a distributed network such as one or more server devices.

In examples, one or more data stores/storages or other memory are associated with system 600. For example, a component of system 600 may have one or more data storage(s) 612 (described below) associated therewith. Data associated with a component of system 600 may be stored thereon as well as processing operations/instructions executed by a component of system 600. Furthermore, it is presented that application components of system 600 may interface with other application services. Application services may be any resource that may extend functionality of one or more components of system 600. Application services may include but are not limited to: web search services, e-mail applications, calendars, device management services, address book services, informational services, etc.), line-of-business (LOB) management services, customer relationship management (CRM) services, debugging services, accounting services, payroll services, and services and/or websites that are hosted or controlled by third parties, among other examples. Application services may further include other websites and/or applications hosted by third parties such as social media websites; photo sharing websites; video and music streaming websites; search engine websites; sports, news or entertainment websites, and the like. Application services may further provide analytics, data compilation and/or storage service, etc., in association with components of system 600. Exemplary system 600 comprises application components 606 including a web search component 608 and an application clustering component 610, where each of the identified components may comprise one or more additional components.

System 600 may further comprise one or more storage(s) 612 that may store data associated with operation of one or more components of system 600. In examples, storage(s) 612 may interface with other components of system 600. Data associated with any component of system 600 may be stored in storage(s) 612, where components may be connected to storage(s) 612 over a distributed network including cloud computing platforms and infrastructure services. Exemplary storage(s) 612 may be any of a first-party source, a second-party source, and a third-party source. Storage(s) 612 are any physical or virtual memory space.

Storage(s) 612 may store any data for processing operations performed by components of system 600, retained data from processing operations, stored programs, code or application programming interfaces (APIs), training data, links to resources internal and external to system 600 and knowledge data among other examples. Furthermore, in examples, components of system 600 may utilize knowledge data in processing by components of system 600. Knowledge may be used by one or more components of system 600 to improve processing of any of the application components 606 where knowledge data can be obtained from resources internal or external to system 600. In examples, knowledge data may be maintained in storage(s) 612 or retrieved from one or more resources external to system 600 by knowledge fetch operation. In examples (as described below) storage(s) 612 may store exemplary data programs/services and other types of data for: management of knowledge data, management of web search indexes, management of exemplary clusters of application data, operations to enumerate applications in app stores, operations to parse platforms for application data, operations to parse web results, operations to determine equivalence among application data, operations to create/update exemplary clusters, and operations for query processing, among other examples.

In FIG. 6, processing device 602 may be any device comprising at least one processor and at least one memory/storage. Examples of processing device 602 may include but are not limited to: processing devices such as desktop computers, servers, phones, tablets, phablets, slates, laptops, watches, and any other collection of electrical components such as devices having one or more processors or circuits. In one example processing device 602 may be a device of a user that is executing applications/services. In examples, processing device 602 may communicate with the application components 606 via a network 604. In one aspect, network 604 is a distributed computing network, such as the Internet. Application services may communicate with application components 606 via the network 604. Processing device 602 may be a device as described in the description of FIGS. 1-3. In some examples, processing device 602 may comprise multiple connected devices. Processing device 602 is an example of a user computing device. In examples, processing device 602 is an example of a device that may send/receive query data. Processing device 602 may be further connected with storage(s) 614 via a distributed network.

The application components 606 are components configured for management of exemplary clusters of application data that may be utilized to improve results data returned during query processing. Application components 606 may comprise a web search component 608 and an application clustering component 610. The web search component 608 is a component that is configured to execute operations related to a web search engine. Such operations are known to one skilled in the art. As an example, the web search component 608 is a component that is configured to provide web results for a received query. For example, a query of “Pokemon application” may yield a variety of URLs related to gaming applications.

The application clustering component 610 is a component that implements processing operations described in the descriptions of process flow 400 (FIG. 4) and method 500 (FIG. 5). As an example, the application clustering component 610 executes processing operations related to the management of clusters of application data, identifying a cluster that corresponds to context of a received query, identifying an application from the cluster that is a best result to return for a query, and providing links to the identified application, among other examples. Continuing the example above where “POKEMON application” was a received query, for example, from a WINDOWS PHONE device, the application clustering component 610 may extract URLs from web results (provided by the web search component 608). The application clustering component 610 may further identify a cluster for POKEMON applications, determine a URL of an application (or URLS of applications) that is best for the device which the query was received (e.g. WINDOWS PHONE). The application clustering component 610 may be configured to provide the URL to that device (and/or other resources such as an email account, user account, etc.).

In examples, the application clustering component 610 may be further configured to maintain information related to query processing including results data provided to user devices. Such data may be maintained in compliance with any privacy laws that respect user privacy.

Reference has been made throughout this specification to “one example” or “an example,” meaning that a particular described feature, structure, or characteristic is included in at least one example. Thus, usage of such phrases may refer to more than just one example. Furthermore, the described features, structures, or characteristics may be combined in any suitable manner in one or more examples.

One skilled in the relevant art may recognize, however, that the examples may be practiced without one or more of the specific details, or with other methods, resources, materials, etc. In other instances, well known structures, resources, or operations have not been shown or described in detail merely to observe obscuring aspects of the examples.

While sample examples and applications have been illustrated and described, it is to be understood that the examples are not limited to the precise configuration and resources described above. Various modifications, changes, and variations apparent to those skilled in the art may be made in the arrangement, operation, and details of the methods and systems disclosed herein without departing from the scope of the claimed examples.

What is claimed is:

1. A method comprising:
enumerating applications for an application store of a platform;
parsing application data of other platforms based on an application name of an enumerated application;
determining one or more equivalent applications for the enumerated application; and
generating a cluster for application equivalence based on the determining, wherein the cluster comprises data for the enumerated application and data for the one or more equivalent applications.

2. The method according to claim 1, wherein the enumerating comprises extracting an application name for the enumerated application.

3. The method according to claim 1, wherein parsing of the application data of other platforms further comprises obtaining search results from a search engine and parsing the search results to identify the application data.

4. The method according to claim 1, wherein the determining of the one or more equivalent applications for the enumerated application further comprises: identifying candidate equivalent applications based on application name, and comparing attribute data of the enumerated application with attribute data of the candidate equivalent applications.

5. The method according to claim 4, wherein the comparing of the attribute data of the enumerated application with the attribute data of the candidate equivalent applications further comprises determining a similarity score for equivalency based on similarity of one or more selected from a group consisting of: an application name, a publisher name, an application category, and description metadata.

6. The method according to claim 4, wherein the comparing of the attribute data of the enumerated application with the attribute data of the candidate equivalent applications further comprises determining a similarity score for equivalency based on similarity of two or more selected from a group consisting of: an application name, a publisher name, an application category, and description metadata.

7. A method comprising:
receiving a query from a computing device;
accessing web results for the received query;
identifying a cluster that comprises application data for equivalent applications of different platforms, wherein the cluster is identified based on an analysis of the web results;
determining a specific application from the cluster based on the computing device associated with the received query; and
outputting data for the specific application.

8. The method according to claim 7, wherein the outputting of the data for the specific application further comprises transmitting the data for the specific application to the computing device.

9. The method according to claim 7, wherein the outputting of the data for the specific application further comprises displaying the data for the specific application on a display.

10. The method according to claim 7, wherein the web results are received from a search engine service.

11. The method according to claim 7, further comprising processing the received query and generating the web results for the received query.

12. The method according to claim 7, further comprising extracting one or more uniform resource locators from the web results, and wherein the cluster is identified using the one or more uniform resource locators extracted from the web results.

13. The method according to claim 7, wherein the cluster comprises a plurality of equivalent applications, and wherein the plurality of equivalent applications comprises versions of a same application that may exist across the different platforms.

14. A system comprising:
at least one processor; and
a memory operatively connected with the at least one processor storing computer-executable instructions that, when executed by the at least one processor, causes the at least one processor to execute a method that comprises:
receiving a query from a computing device,
accessing web results for the received query,
identifying a cluster that comprises application data for equivalent applications of different platforms, wherein the cluster is identified based on an analysis of the web results,
determining a specific application from the cluster based on the computing device associated with the received query, and
outputting data for the specific application.

15. The system according to claim 14, wherein the outputting of the data for the specific application further comprises transmitting the data for the specific application to the computing device.

16. The system according to claim 14, wherein the outputting of the data for the specific application further comprises displaying the data for the specific application on a display.

17. The system according to claim 14, wherein the web results are received from a search engine service.

18. The system according to claim 14, wherein the method, executed by the at least one processor, further comprises: processing the received query and generating the web results for the received query.

19. The system according to claim 14, wherein the method, executed by the at least one processor, further comprises: extracting one or more uniform resource locators from the web results, and wherein the cluster is identified using the one or more uniform resource locators extracted from the web results.

20. The system according to claim 14, wherein the cluster comprises a plurality of equivalent applications, and wherein the plurality of equivalent applications comprises versions of a same application that may exist across the different platforms.
